(19) United States
(12) Patent Application Publication
(10) Pub. No.: US 2026/0363377 A1
(43) Pub. Date: Nov. 19, 2026

(54) BATTERY PACK, HELMET ACCESSORIES SYSTEM AND PROTECTIVE HELMET SYSTEM WITH VIBRATION ALARM AND METHOD FOR OPERATING SUCH A HELMET ACCESSORIES SYSTEM

(71) Applicant: Pfanner Schutzbekleidung GmbH, Koblach (AT)

(72) Inventor: Anton PFANNER, Hohenems (AT)

(73) Assignee: Pfanner Schutzbekleidung GmbH, Koblach (AT)

(21) Appl. No.: 19/142,957

(22) PCT Filed: Dec. 18, 2023
(86) PCT No.: PCT/EP2023/086404

§ 371 Date: Jun. 24, 2025

(30) Foreign Application Priority Data
Dec. 28, 2022 (DE) 10 2022 134 905.5

(51) Int. Cl. A42B 3/04; G08B 6/00; H01M 10/42; H01M 50/247; H01M 50/264

(52) U.S. Cl. CPC A42B 3/044; A42B 3/0453; G08B 6/00; H01M 10/425; H01M 50/247; H01M 50/264; H01M 2010/4278

(57) ABSTRACT

A battery pack fastens to a protective helmet and for energy supply of a helmet accessory, including a battery module for storing and outputting electrical energy; a supply and communication terminal for energy supply of a helmet accessory which can be coupled with the battery pack and for communication; mounting means for fastening the battery pack to the protective helmet; a vibration module for generating body sound; a control unit for controlling the functions of the battery pack, including the function of the vibration module; wherein the control unit is adapted to drive the vibration module based on a communication signal received at the supply and communication terminal. The invention further relates to a helmet accessory system comprising a battery pack and a helmet accessory as well as a protective helmet system comprising a protective helmet and a helmet accessory system. A method operates a helmet accessory system.

The invention relates to a battery pack, a helmet accessories system and a protective helmet system, respectively with a vibration alarm, as well as a method for operating such a helmet accessories system.

Many jobs, especially in the forestry sector, require wearing a protective helmet. A corresponding protective helmet, which comprises a helmet shell with an interior fitting with an assembly which touches the head and at least one support cage, a head band and a neck band, and means for fastening this assembly to the helmet shell, is known, for example, from DE 87 14 490 U1 .

This known protective helmet represents a basic helmet which can be adapted to the various tasks under different employment conditions by changing add-on elements. The protective helmet consists of a helmet shell and a minimum interior fitting. The interior fitting consists of a cruciate band, with which the helmet is worn on the head and which guarantees an impact-resistant distance between the head and the helmet shell. On its outer circumference, the protective helmet has a projection which surrounds the lateral and the rear part of the helmet and which contains, at the lower rim, four recesses for fastening the cruciate band and further recesses for fastening additional add-on elements. The basic version of the helmet can be used as a simple universal helmet without any extras. The extras can be added or removed as required.

The helmet accessories which are to be fastened to the protective helmet in a meaningful manner also include a helmet light which additionally illuminates, in particular in a manner similar to a headlamp, for example the operating range of a user of the protective helmet or other areas. Such additional illumination of the operating range or other areas can be expedient not only during dawn and dusk and after nightfall, but also in areas shielded from daylight, for example the twilight under a closed tree crown. Further, a helmet light which can be fastened to the protective helmet can also be advantageous in the most varied of activities. For example, nightly repairs to construction machinery on construction sites or maintenance work in dark, poorly lit supply tunnels or under bridges can be executed in a better and more efficient way if a suitable lighting means in the form of a helmet light is carried “on the man” ready to be employed.

Such helmet lights usually generate light from electrical energy, wherein the electrical energy required for this is normally stored and carried along in a chemical form, for example as a battery pack or a rechargeable battery pack.

A further useful helmet accessory represents a hearing protection which can be worn during the use of the protective helmet in order to mitigate possibly present noise, for example during forestry or construction work. In doing so, however, all sounds in the environment of the user are mitigated so that they also perceive other acoustic signals worse. Further, the loud environmental sounds themselves already prevent perceiving acoustic (warning or information) signals. Such signals the user usually is to perceive in a reliably manner, comprise, for example, all acoustic signals of a mobile phone carried along. In order to improve the perception of signals of a mobile phone, it is already known to equip it with a vibration alarm. However, such a vibration alarm is also only difficult to perceive due to physical activities carried out by the user of the protective helmet at that moment and protective clothing to be worn in doing so, which can comprise additional cushions, cutting protection etc.

The present invention is based on the object of solving or at least mitigating this problem.

This object is achieved with the help of the subject matters with the features of the independent claims. Useful designs and further developments result from the dependent claims.

The battery pack according to the invention for fastening to a protective helmet and for energy supply of a helmet accessory provides that the battery pack comprises a battery module for storing and outputting electrical energy, a supply and communication terminal for energy supply of a helmet accessory which can be coupled with the battery pack and for communication; mounting means for fastening the battery pack to the protective helmet; a vibration module for generating body sound; a control unit for controlling the functions of the battery pack, including the function of the vibration module; wherein the control unit is adapted to drive the vibration module based on a communication signal received at the supply and communication terminal. In this way, acoustic and tactile signals, the output of which is communicated or requested by another device, for example a mobile phone communicatively connected to the battery pack which charges the battery pack with energy and/or supplies the helmet accessory, from the control unit of the battery pack by means of a communication signal sent to the supply and communication terminal, communicated to the user in a reliable manner via the protective helmet itself. The communication signal, which requests an activation of the vibration module, can reach the communication terminal in different ways, for example via a completely wired connection or an at least partially radio-based connection, for example Bluetooth, NFC or the like.

Usefully, it can be provided that the vibration module is integrated in a battery body or integrally formed with the mounting means. In this way, the battery body or the battery pack comprising the battery body or the mounting means can have a double function. The battery body then serves, on the one hand, the energy supply of the helmet accessory and at the same time the output of a tactile notification signal to the user of the protective helmet. Alternatively, the mounting means serves the fastening of the battery pack and at the same time the output of the tactile notification signal to the user of the protective helmet.

Alternatively, it can be provided that the vibration module is detachably fastened to the battery body or detachably fastened to the mounting means. In this way, an optional retrofitting of the battery pack or of the mounting means can be enables, wherein, through the retrofitting, the double functionality already mentioned above is achieved.

Advantageously, it can be provided that the vibration module comprises holding means which fix the vibration module on the battery pack or the mounting means. In this way, the respective designs of the battery pack or of the mounting means can be kept very simple, which realizes a retrofitting of an already present battery pack (with associated mounting means), which is at least roughly prepared for such a retrofitting, in a cost-effective manner.

Further, it can be provided that the holding means are adapted to fix the vibration module magnetically and/or mechanically. Both magnetic fixation and mechanical fixation, for example with the help of a clamping device, allow the simple and reliable realization of a detachable fastening of the vibration module on the battery pack or the mounting means.

It can also be provided that an electrical connection between the battery pack and the vibration module is formed by means of the holding means. In this way, the provision of additional electrical contacts for joining/connecting the vibration module to the battery pack can be dispensed with.

Usefully, it can be provided that the vibration module comprises a bearing surface which bears against a helmet shell of the protective helmet when the battery pack is fastened to the protective helmet by means of the mounting means. By providing the bearing surface, a particularly efficient transmittion/introduction of the generated tactile vibration signal into the helmet shell of the protective helmet acting as a resonance body can be achieved. Correspondingly, a vibration module which only consumes little electrical energy is required, which increases energy efficiency.

In particular, it can also be provided that the battery pack comprises at least one sensor unit which detects an operating state of the battery pack and that the control unit is adapted to drive the vibration module based on the detected operating state. In this way, the battery pack itself and independently can send the user of the protective helmet tactile (vibration) signals which catch their attention. For example, charging state warnings, temperature warnings etc. can be output.

It can further be provided that the control unit is formed to drive the helmet accessory synchronously to the vibration module. In this way, the attention of the user can be directed to the signal output by the vibration module in an even more efficient way.

A helmet accessory system according to the invention comprises such a battery pack and a helmet accessory, in particular a helmet light, wherein the battery and the helmet accessory can be fastened o are fastened to a helmet shell of the protective helmet. A protective helmet system according to the invention comprises a protective helmet and such a helmet accessory system. In this way, the present object is also achieved by a helmet accessory system and a protective helmet system.

A method according to the invention for operating such a helmet accessory system comprises receiving a communication signal on a supply and communication terminal of the battery pack and driving, through a control unit, a vibration module based on the received communication signal. In this way, the present object is althrough achieved through a method.

Otherwise, the further advantages described in connection with the battery pack can be realized analogously with the helmet accessory system and the protective helmet system as well as the present method, wherein the respective considered physical features of the battery pack are optionally considered in a method manner.

Exemplary designs of the invention or of some components and constituents of the invention are described in more detail below with reference to the drawings.

In the drawings:

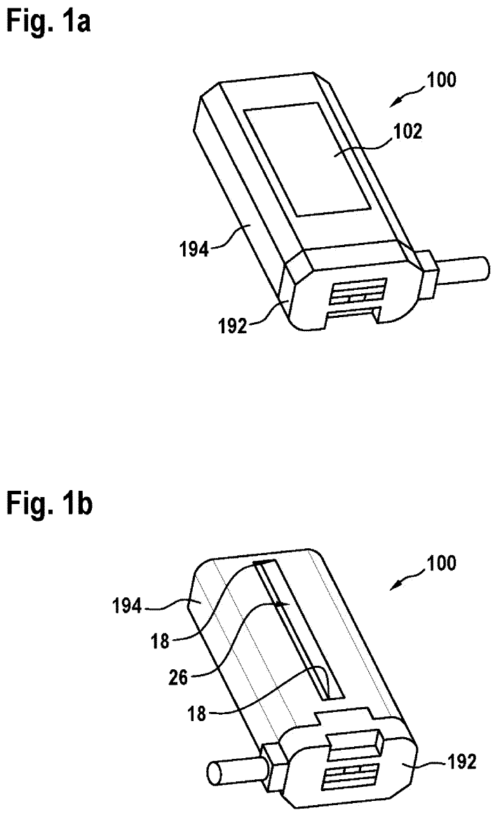

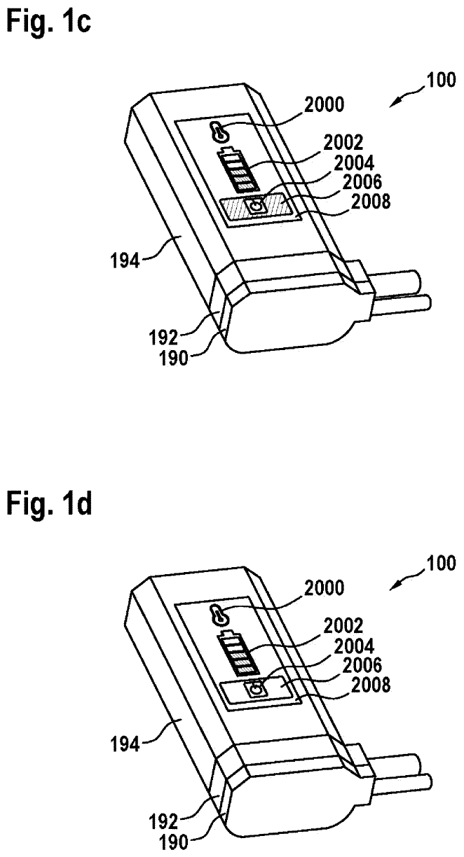

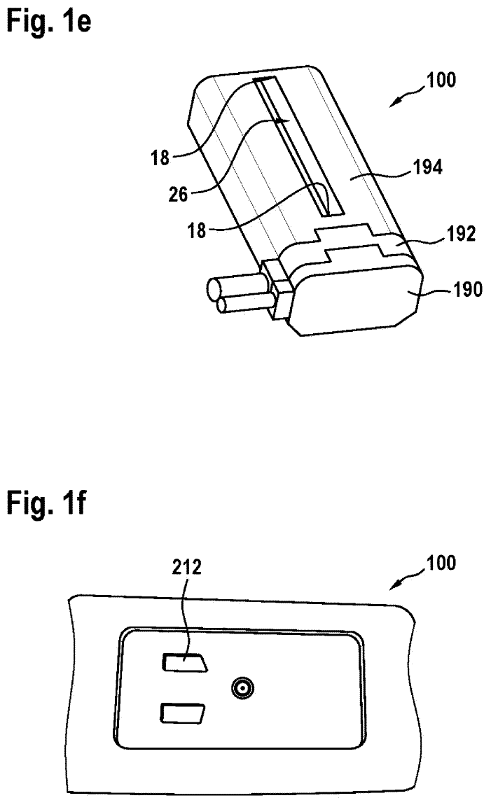

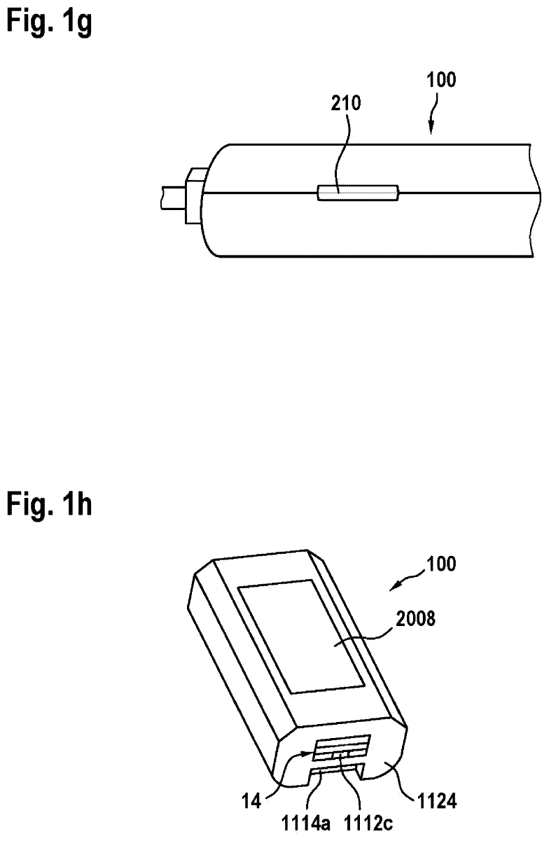

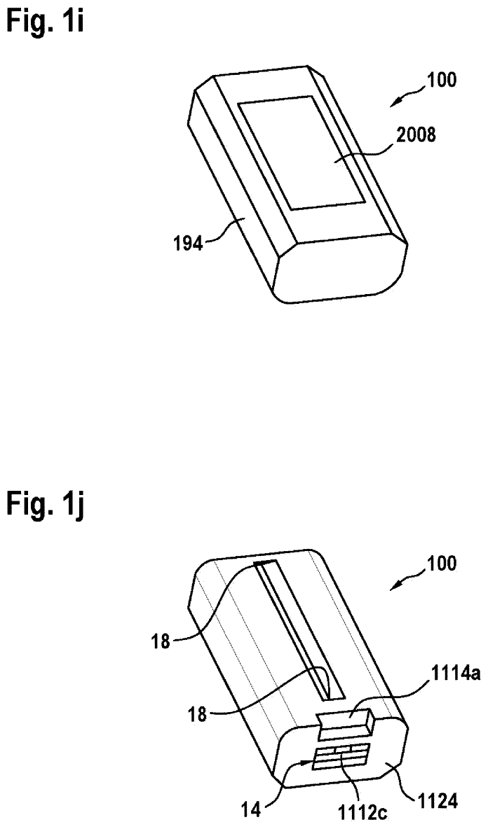

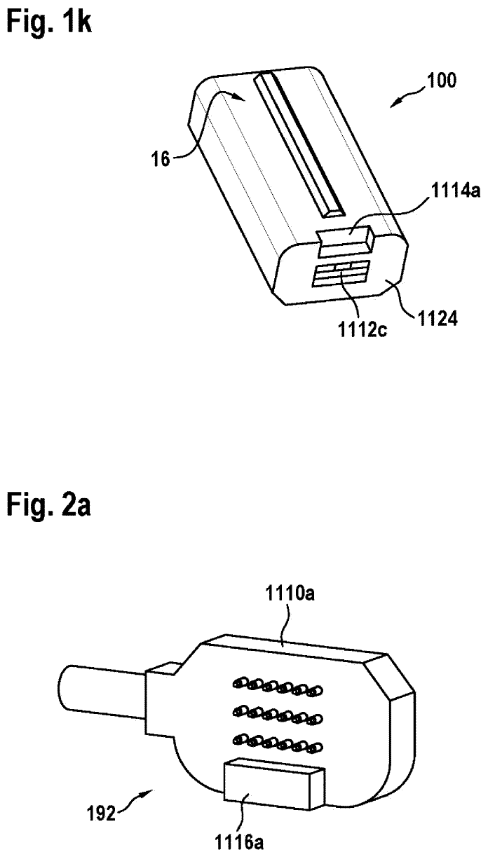

FIGS. 1a to 1k show three-dimensional external views of a battery pack from different viewing directions and in different embodiments;

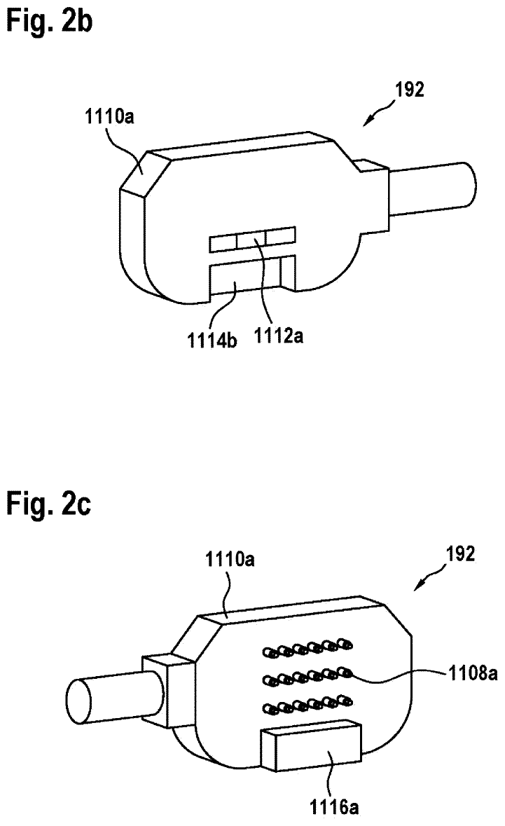

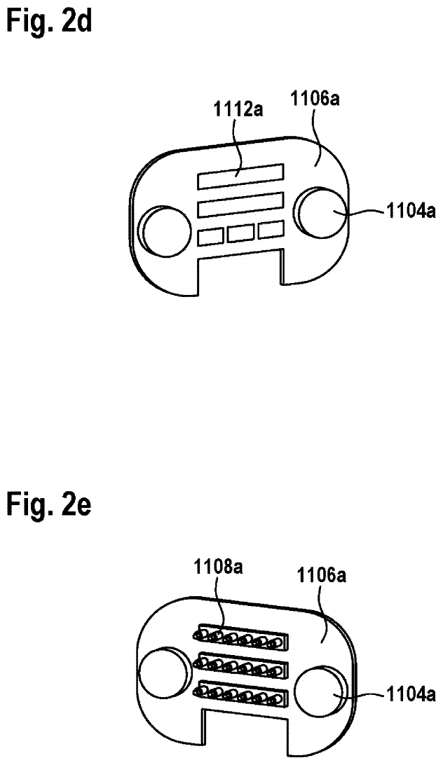

FIGS. 2a to 2c show three-dimensional representations of a connector plug from different viewing directions;

FIGS. 2d and 2e show an internal setup of a connector plug from different viewing directions;

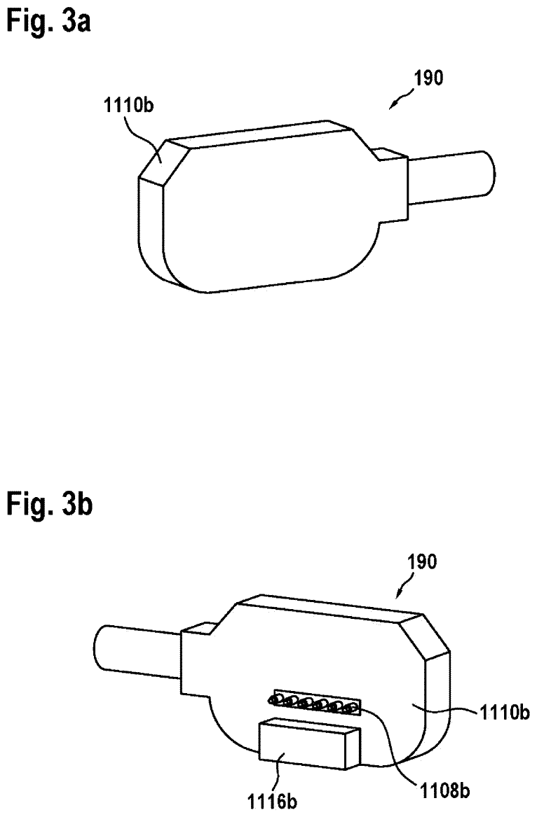

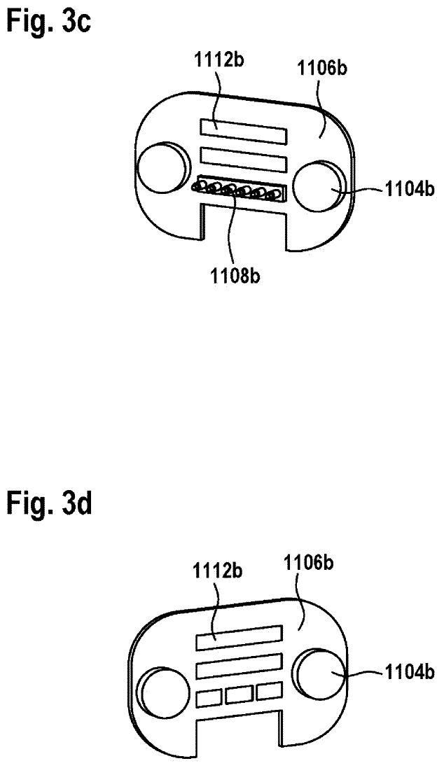

FIGS. 3a and 3b show a three-dimensional external view of a charging plug from different viewing directions;

FIGS. 3c and 3d show an internal setup of a charging plug from different viewing directions;

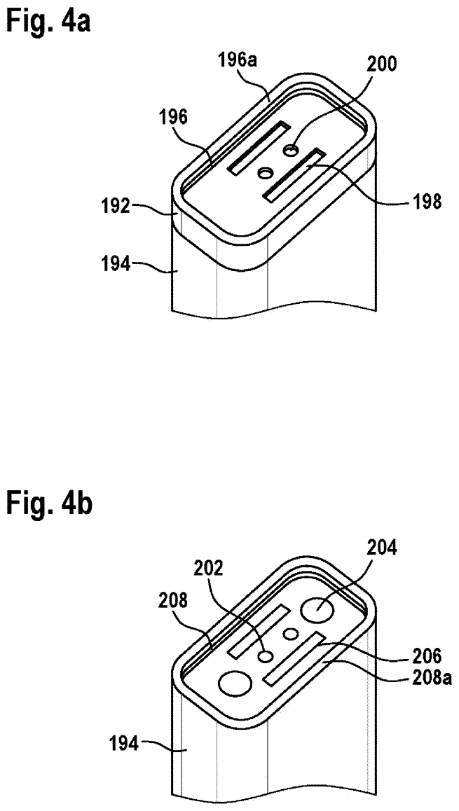

FIGS. 4a and 4b show three-dimensional representations of a charging connection of a battery pack;

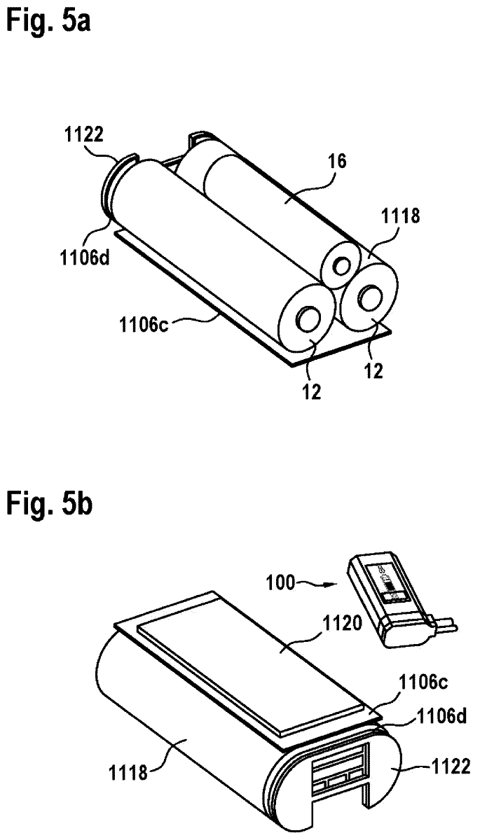

FIGS. 5a and 5b show an internal setup of a battery pack from different viewing directions;

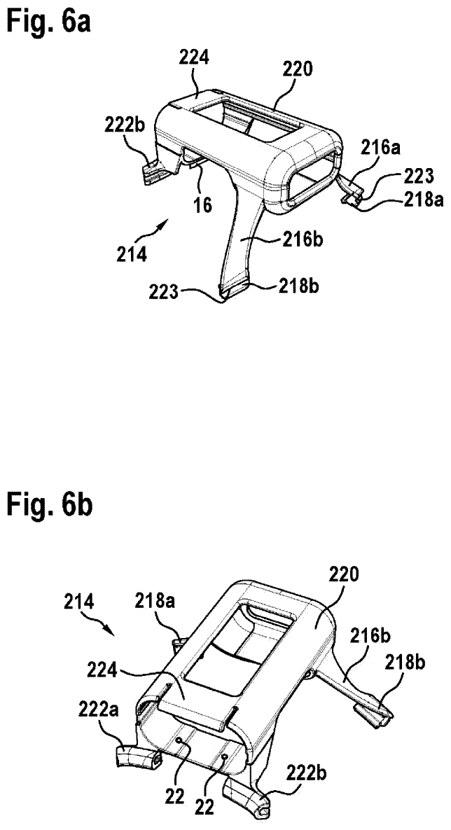

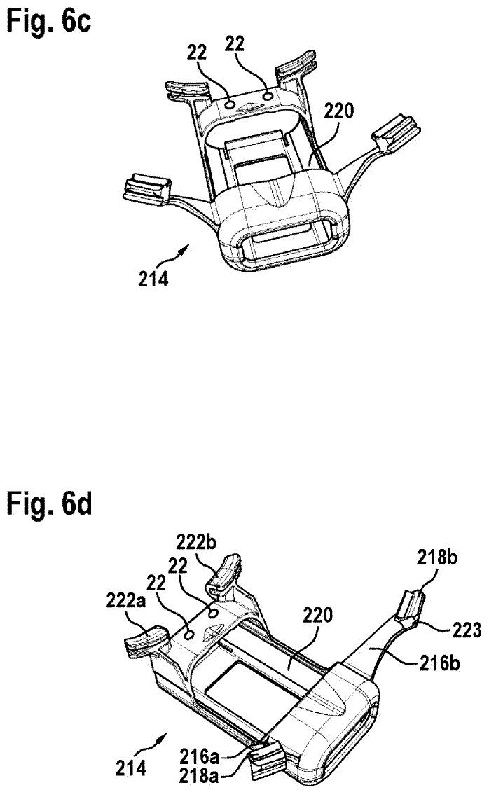

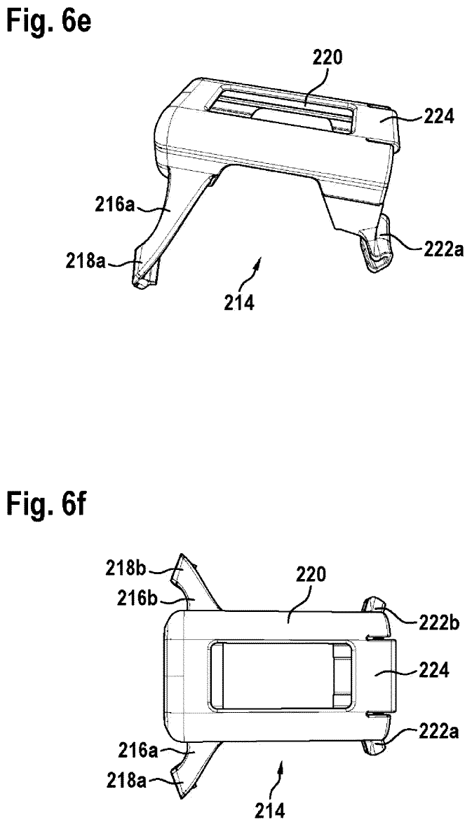

FIGS. 6a to 6f show three-dimensional representations of a mounting means from different viewing directions;

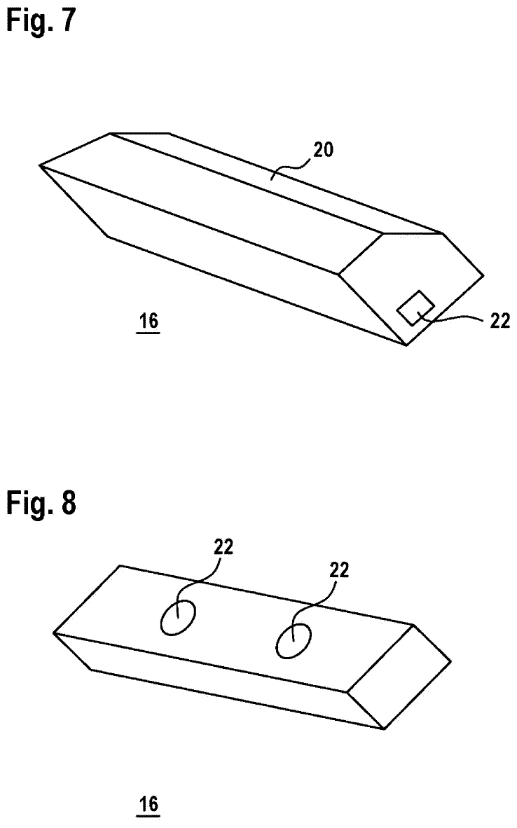

FIG. 7 shows a first three-dimensional view of a vibration module;

FIG. 8 shows a second three-dimensional external view of a vibration module;

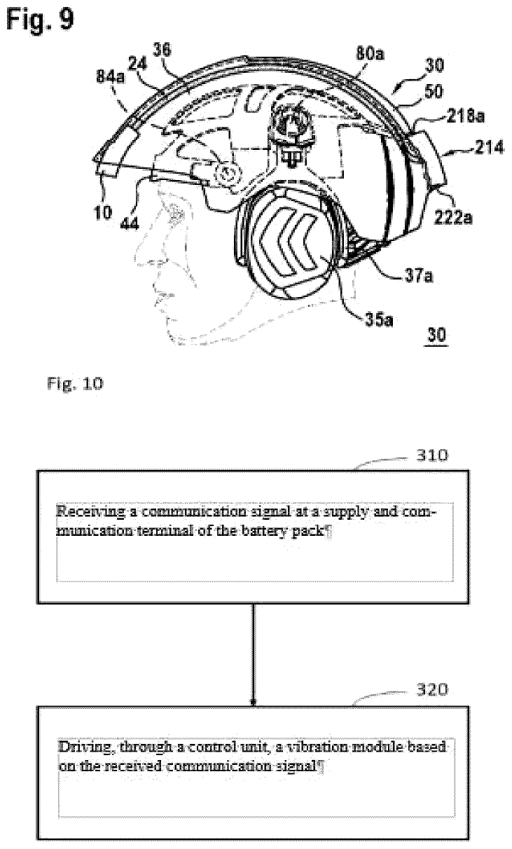

FIG. 9 shows a lateral sectional view of a protective helmet with a helmet light fastened thereto and a battery pack; and;

FIG. 10 shows a flow chart of a method for operating a helmet accessory system.

In the following description of the drawings, identical reference numerals denote identical or comparable components.

FIGS. 1a to 1k each show three-dimensional external views of a battery pack 100. The representations are partially simplified, so as not to be dominated by insignificant details. FIG. 1a shows the battery pack 100 in the deactivated state. The battery pack 100 represented in FIG. 1a comprises a substantially elongated and cuboid battery body 194, the edges of which are beveled, as represented in FIG. 1a. Rounding of the edges is also conceivable as an alternative. On one side of the battery body 194, a display and operating element 102 in the inactive state is represented in FIG. 1a. In the lower area of the battery pack 100, a connector plug 192 can be recognized. The battery pack 100 can be connected to a helmet light 10 which is represented, for example, in FIG. 9, with the help of the connector plug 192. In FIG. 1a, the battery pack 100 is represented in its deactivated state, so that consequently the display and operating element 102 shows “nothing”. However, it is conceivable, for example, that the display and operating element 102 can be used for switching individual display elements on and off on the display and operating element 102 and can accordingly also be “labeled” in order to also identify the operating element without current.

FIG. 1b shows the battery pack 100 from a side which is opposite the display and operating element 102 from FIG. 1a, so that the rear side of the battery pack 100 is visible. The rear side of the battery pack 100 can be structured in different ways as needed.

FIG. 1c shows the battery pack 100 in an activated state. The display and operating element 102 from in FIG. 1a, which is not separately designated, shows various information for a user, in particular when the battery pack 100 itself is activated. The display and operating element 102 can, for example, graphically represent a temperature display 2000, a battery charging level display 2002, and an on/off button 2004, optionally with an LED backlight 2006. For this purpose, the display and operating element 102 can have a display area 2008, under which an on/off switch element, in particular as a foil switch, can be arranged, so that touching the represented on/off switch 2004 can, for example, cause the battery pack 100 or the connected helmet light 10 to be switched on and off. The temperature display 2000 can, in particular, graphically represent the temperature of the battery pack 100. This may be important because the capacity and output performance of the battery pack 100 varies with temperature. The display area 2008 can, of course, optionally also graphically represent other or further information on the helmet light 10 or on the battery pack 100. For example, in the display area 2008, error messages of the helmet light 10 could be graphically represented if the battery pack 100 is coupled to the helmet light 10 via the connector plug 192. Below the connector plug 192, a charging plug 190 can also be recognized in FIG. 1c. The charging plug 190, as represented in FIG. 1c, can be coupled to the battery pack 100 when the connector plug 192 is interposed. Alternatively, it is also possible for the battery pack 100 to be coupled directly to the charging plug 190 without an interposed connector plug 192. The LED backlight 2006, which is indicated in FIG. 1c by a hatching around the on/off button 2004, can also provide a “rear light function” for the user, for example, if required, since the alignment of the battery pack 100 in the mounted state on the protective helmet 30 permits a corresponding functionality. Alternatively or additionally, one or more, in particular red, LEDs can be separately provided on the housing of the battery body 194.

The external view of the battery pack 100 shown in FIG. 1d corresponds to FIG. 1c with respect to the viewing angle represented. Compared with FIG. 1c, however, the battery pack 100 in FIG. 1d is represented in a different operating state. In the case of the battery pack 100 represented in FIG. 1c, the LED backlight 2006 is activated, which is indicated by the hatching used. In the case of the battery pack 100 represented in FIG. 1d, the LED backlight 2006 is deactivated, which is indicated by the absence of hatching. In the same way, in the area of the battery charging level display 2002, recognizable hatches can visualize the current charge level of the battery pack 100. The temperature display 2000 can, for example, visualize the temperature of the battery pack 100 with the help of a color change or in another suitable manner. Alternatively, it is also conceivable that in the vicinity or instead of the symbol recognizable in FIG. 1d, the temperature display 2000 directly represents the temperature of the battery pack 100 in figures. The on/off button 2004 represented, for example, in FIGS. 1c and 1d can provide different functions. For example, the on/off button 2004 can switch a helmet light 10 connected to the battery pack 100 on or off. As long as no helmet light 10 is connected to the battery pack 100, the on/off button 2004 can, for example, place the battery pack 100 itself in different operating states, for example it can be provided to interrogate at least some of the information which can be displayed on the display area 2008 with its help and in particular to activate or deactivate the battery charging level display 2002. The change of the functions provided by the on/off button 2004 can be effected as a function of the plugs respectively connected to the battery pack 100, i.e. the charging plug 190 and the connector plug 192, wherein an internal logic circuit of the battery pack 100 recognizes, based on measurable voltages at the connecting contacts of the battery pack 100 described in more detail below, which plugs are connected to the battery pack 100. The internal logic circuit of the battery pack 100 can be regarded as rudimentary control unit of the battery pack which can drive or provide some basic functions of the battery pack 100. The special design of the charging plug 190 and the connector plug 192 permits the simultaneous connection of the connector plug 192 and the charging plug 190 to the battery pack 100, so that in this way, for example, also several batteries can be connected simultaneously to the helmet light 10 of the helmet light system. Further, the charging of the battery pack 100 during the use of the helmet light 10 is also possible.

The helmet light system can, in addition to the helmet light 10, which can be switched in several operating modes and states, comprise a transmitting and receiving module and an input device with a further transmitting and receiving module. The input device can then be connected to the helmet light 10 via the transmitting and receiving module and the further transmitting and receiving module in the form of a 2-way communication. The input device can be a mobile phone, for example. As a result, the helmet light 10 can be controlled via the input device and the input device can also receive operating information from the helmet light 10 in the reverse direction when the helmet light 10 is connected to the input device. In this way, the input device can be positioned as an operating unit for the helmet light 10 as desired and can be arranged, in particular, in the view of the user, so that the operation of the helmet light system is simplified. The transmitting and receiving module and the further transmitting and receiving module can be radio modules or cable-bound modules. The 2-way communication between the helmet light 10 and the input device can be established via a common communication protocol. The use of a common communication protocol also allows to realize a more complex control of the helmet light system, which goes beyond a simple closing of an electrical circuit for switching on and off. The control of the helmet light system can be correspondingly flexible. The input device can in particular send a communication signal to the battery pack 100, optionally via the helmet light 10 and from there to the battery pack 100 in order to drive the vibration module 16 described hereinafter. Other components of the helmet light system can also send communication signals to the battery pack 100 in order to drive functions of the battery pack, in particular in order to drive the vibration module 16.

The 2-way communication used can be protected by encryption. In this way, unintentional external operation by any input device which connects randomly to the helmet light 10 of the helmet light system can be prevented. This is particularly expedient if several helmet light systems are used in each case with their own input devices close together. In this context, provision may be made for the entry of a password in order to secure the connection. The operating information received by the input device can also comprise status information of the helmet light system. The input device can then output the status information of the helmet light system. This also facilitates the operation of the helmet light system. The helmet light 10 of the helmet light system can also be connected to a further input device, while it is already connected to the input device. It is possible that the helmet light 10 is then controlled primarily by the further input device. In this way, for example, priority operation can be performed by an operational director or a monitoring system installed at a location, for example switching on a camera, a helicopter light or a position light if the helmet light system has such possibilities. Likewise, the switching off of individual operating functions can be prevented by the higher-level instance or an output of a tactile vibration signal by means of the vibration module 16 can be initiated.

The helmet light system, which already comprises at least one helmet light 10 with a control controller and can be switched by the control controller into several operating modes and states, can be supplemented by a camera unit, which is then operatively connected to the control controller. The control controller can activate the connected camera unit as soon as the helmet light 10 of the helmet light system is activated. It is also possible that the activation already takes place as long as the helmet light system is in a stand-by mode and does not emit any light yet. This allows an automated documentation of what the user of the helmet light system does and sees, in particular, it can be avoided that the user forgets to comply with a possible documentation obligation. Activating or deactivating individual components of the helmet light system, for example of a camera unit or of a helicopter light, can be displayed to the user in a tactile manner by means of a vibration signal through the vibration module, in particular through specially coded vibration patterns which can identify the performed change of the operating state of the helmet light system in a unique manner.

The camera unit can store recorded videos internally. In this way, longer-term archiving can take place. The camera unit can also send recorded videos to the helmet light 10, for example for storage in a memory integrated into the helmet light 10. In this way, too, longer-term archiving can take place. It is preferably provided that the control controller transmits videos recorded by the camera unit as operating information to an external storage device which can be connected to the helmet light system. In this way, a virtually unlimited documentation period can be realized. The external storage device can also be called up by a third party, in particular for the optical representation of the video, in order, for example, to provide assistance to the user of the helmet light system in the event of a problem. For example, to instruct the user on the problem. In particular, for this purpose, the helmet light system can comprise a headset, via which the user can communicate with a third party, which provides the assistance. The communication can take place, for example, via a mobile radio connection, wherein the helmet light system is coupled, for example, to an input device providing the mobile radio connection, for example a mobile telephone. The control controller can be set up to adjust a recording direction of the camera unit as a function of an operating mode and/or an operating state of the helmet light 10. This can improve the quality of the recordings taken by the camera. In particular, a recording direction and a brightness of the produced recording can be set.

The control controller can also be set up to adjust a dynamic focal length of the camera unit as a function of an operating mode and/or an operating state of the helmet light. In this way, too, a recording quality of the camera can be improved. This can be done, for example, by adjusting the zoom, for example, to widen or reduce the viewing angle.

The properties of the helmet light system described above can also be generally implemented and realized within the framework of a method for operating a helmet light system, which can then be executed by the control controller of the helmet light. All changes of the operating state of the helmet light system mentioned above can be additionally displayed to the user through a confirmation signal, wherein, for this purpose, a respective communication signal can be sent to the battery pack and then, a characteristic vibration sequence can be output through the vibration module 16.

FIG. 1e shows the battery pack 100 from the rear, wherein, in contrast to FIG. 1b, in addition to the connector plug 192, the charging plug 190 is also connected to the battery pack 100. The functioning of the plugs will be explained in more detail below.

FIGS. 1f and 1g show three-dimensional detailed views of a battery pack 100. FIG. 1f shows a section of an upper side of the battery pack 100 and FIG. 1g shows a section of a side of the battery pack 100. A pair of detent lugs 212 can be recognized on the upper side. On the side of the battery pack 100 there is a lateral detent lug 210. Expediently, if a lateral detent lug 210 is provided on one side, a further lateral detent lug can be provided on the opposite other side. The detent lugs 212 and the lateral detent lug 210 (as well as a possible further lateral detent lug) can cooperate in particular with a mounting means 214, which will be described in the following, and fix the battery pack 100 with the help of the mounting means 214 to the protective helmet 30. The detent lugs 212 and the lateral detent lug 210 are represented only in FIGS. 1f and 1g, but can also be provided in the battery packs 100 represented in the other figures.

FIGS. 1h, 1i, 1j and 1k show the battery pack 100 from different viewing angles without connected plugs. The battery pack 100 represented in FIG. 1h is in a switched-off operating state, so that the display area 2008 displays nothing. However, it is also conceivable that the display area 2008 also shows at least the on/off button 2004 in the currentless state, for example in the form of a transparent foil image. In the lower area of the battery pack 100, electrical contact surfaces 1112c are visible on an end face 1124 of the battery body 194. Further, a notch-like recess 1114a is visible, which serves for centering the connector plug 192 or the charging plug 190 and at the same time prevents a lateral shearing of the plugs from the battery pack 100 in the mounted state. FIG. 1f shows the battery pack 100 from another side, so that the recess 1114a on the end face 1124 of the battery body 194 can be recognized more clearly. FIG. 1i represents the battery pack 100 in such a way that the further end face of the battery pack 100 opposite the end face 1124 is visible, which may be designed, for example, completely smooth. If required, however, further connection possibilities, in the form of electrical contact surfaces, guide elements or additional operating elements can also be arranged on this further end face. The represented connection possibilities can in particular already represent a supply and communication terminal on which the communication signal can be received for driving the vibration module 16.

In FIGS. 1b, 1e and 1j, a respective back side of the battery body 194 opposite the display area 2008 can be recognized. On this back side of the battery body 194, a recess 26 can be seen in the middle. The recess 26 serves to receive the vibration module 16, as individually represented, for example, in connection with FIGS. 7 and 8. On the opposite boundary surfaces of the recess 26 (in an axial main extension direction of the battery body 194), provided holding means 18 are indicated. These holding means 18 can be formed, for example, in the shape of holding magnets which magnetically fixate the vibration module 16 in the recess 26. At the same time, the electrical contact required for operating the vibration module 16 can be realized via the holding magnets since these can be connected in an electrically conductive manner to (metallic) contacts 22 on the vibration module 16 when the vibration module 16 is fastened to the battery pack 100.

FIG. 1k further represents a battery body 194 wherein the vibration module 16 is integrated in the battery body 194 itself. Accordingly, instead of the recess 26, an elevation trapezoidal in cross-section (cross-section to the axial main extension direction of the battery body 194) is present on the housing of the battery body 194 which is formed/caused by the vibration module 16 beneath.

When the vibration module 16 is inserted into the recess 26 represented in FIG. 1b, 1e or 1j, the combination of the battery body 194 and the vibration module 16 can have external dimensions corresponding the ones of the battery body 194 of FIG. 1k.

FIGS. 2a, 2b and 2c show three-dimensional representations of a connection plug 192 from different viewing directions. FIGS. 2a and 2c show a connection side of the connector plug 192 provided with an electrical contact 1108a. A projection 1116a is clearly recognizable on this connection side which forms, together with the recess 1114a which can be recognized, for example, in FIG. 1f, a guide element which assists in positioning the connector plug 192 on the battery pack 100. The projection 1116a centers the connector plug 192 together with the notch 1114a of the battery pack 100 on the battery pack 100. In this way, a blind joining of the battery pack 100 with the battery plug 192 can be made possible. FIG. 2b shows a representation of the battery plug 192 from the side opposite the electrical contact 1108a.

The electrical contact 1108a can comprise individual pin contacts. These pin contacts can be designed, for example, to be telescopically compressible, wherein in particular a prestress for the extended state of the pin contacts can be provided. In this way, when the connector plug 192 is brought together with the battery pack 100, electrical contact closure can be reliably guaranteed by a contact pressure which is produced, without there being any risk of bending of the electrical contact 1108a on the respective associated electrical contact surface 1112c, which may be embodied in particular as a smooth or flat surface. The individual pin contacts can have, for example, spring-like elements in order to achieve the prestress. However, alternative designs are also known to the person skilled in the art. This design also permits a lateral disconnection of the plug from the battery pack.

A recess 1114b is again provided on the side opposite the electrical contact 1108a, which is represented in FIG. 2b, i.e. on the rear side of the battery plug 192. Further, an electrical contact surface 1112a can also be recognized, wherein the electrical contact surface 1112a serves for the electrical connection of the connector plug 192 to the charging plug 190.

The entire interior of the connector plug 192 can be cast by means of a casting compound 1110a. The casting compound 1110a then forms the housing of the battery plug 192. Alternatively, it is also possible to produce with housing shells which are then tightly connected to one another in order to achieve a functionality, in particular a fluid tightness, of the housing which is analogous to the casting compound 1110a. The provision of interconnected housing shells can have advantages with regard to exchangeability or control of the individual parts in the interior of the connector plug 192, thus improving the environmental friendliness of the helmet light 10 as a whole.

With the help of the different possible and matching combinations of projections 1114a, 114b and recesses 1116a, 1116b, a simple joining aid for the plug connection can be realized, which does not impede the simple release in the case of a tensile force on the connector plug 192 and at the same time ensures that, in the absence of a tensile force, the electrical contacts closed with the help of the plug connection remain securely and, above all, correctly connected to one another. If the respective projections and recesses are arranged asymmetrically on the contact surfaces, a simple anti-rotation protection is realized.

FIGS. 2d and 2e show a possible internal setup of a connector plug 192 from two substantially opposite viewing directions, so that a front side and a rear side of the inner setup are visible. For the sake of simplicity, cable connections of the connector plug 192 leading away from the connector plug 192 were omitted. A PCB 1106a, on which the already known electrical contact 1108a is arranged, is located inside the connector plug 192, covered by the casting compound 1110a or a housing fulfilling the same function. The electrical contact surface 1112a can be recognized on the opposite side. Both the electrical contact 1108a and the electrical contact surface 1112a reach through the casting compound to the surface of the connector plug 192, so that further elements can be electrically contacted with the connector plug 192 on both elements. Two magnets 1104a are located in the lateral area of the PCB 1106a. The magnets 1104a cooperate with corresponding counterparts in the battery pack 100 or the charging plug 190, so that a polarity reversal of the electrical connections can be ruled out during the connection. This serves as an additional safety measure. Further, the magnets 1104a together with the corresponding counterparts on the battery pack 100 pull the connector plug 192 automatically into the correct position and ensure a secure holding together between the connector plug 192 and the battery pack 100 even under mechanical loading in the joining direction.

By means of this coupling and connecting mechanism, it is possible overall for interlocking cable loops of the connection cable 24 to be able to open if the user of a protective helmet 30 equipped with the helmet light system makes an uncareful movement while wearing the protective helmet 30. As soon as the tension on a hooked cable loop exceeds the holding force which can be applied by the magnets 204, 1104a, 1104b, the connector plug 192 is automatically released from the battery pack 100 while the cable loop opens. This release can trigger an activation of the vibration module 16 through the rudimentary control unit provided in the battery pack in order to inform the user about this incidence, the separation of the helmet light 10 from the battery pack 100, which is advantageous, in particular, when the helmet light 10 comprises a smaller integrated energy storage for such emergencies. Further, the connection of the connector plug 192 to the battery pack 100 is facilitated, since the magnets 204, 1104a, 1104b automatically pull the two components of the plug connection into the correct position, so that the blind closing of the connection is greatly simplified. The (re)establishment of the connection can also trigger a vibration signal through the vibration module 16.

FIGS. 3a and 3b show three-dimensional external views of a charging plug 190 from different viewing directions. The charging plug 190 already known from FIGS. 1d and 1e likewise has a projection 1116b, similar to the connector plug 192. Further, an electrical contact 1108b on the same side of the charging plug 190 is also provided. Analogously to the connector plug 192, the housing of the charging plug 190 is likewise formed by a casting compound 1110b, wherein a fluid-tight setup of individual housing elements, in particular housing shells, is also possible here. On the side of the charging plug 190 represented in FIG. 3a, which is opposite the side with the electrical contact 1108b, there is no electrical contact surface, unlike in the case of the connector plug 192. With the help of the possible combinations of the projection 116b and the recess, a simple joining help for the plug connection can be realized, which does not impede the simple release in the case of a tensile force on the connector plug and at the same time ensures that, in the absence of a tensile force, the electrical contacts closed with the help of the plug connection remain securely and, above all, correctly connected to one another. Pulling or connecting the charging plug 190 can also trigger a vibration signal through the vibration module 16, analogously to the connecting and pulling of the connection plug 192.

In this context, it can be provided that the projection and the recess are each asymmetrically formed, preferably at one rim, of the respective connection surfaces. Thereby, a simple anti-rotation protection is realized.

FIGS. 3c and 3d show a possible internal setup of a charging plug 190 from two substantially opposite viewing directions, so that a front side and a rear side of the inner setup are visible. In each case, a PCB 1106b of the charging plug 190 provided in the interior of the charging plug 190 is shown, on which, analogously to the connector plug 192, electrical contact surfaces 1112b and an electrical contact 1108b and magnets 1104b are likewise provided.

The setup of the represented PCB 1106b thus largely resembles the setup of the PCB 1106a already known from FIGS. 2d and 2e. Since the PCB 1106b is associated with the charging plug 190, the PCB 1106b can have a different setup with respect to the represented electrical contact surfaces 1112b and the electrical contact 1108b, which in particular comprises fewer individual electrical contact pins of the electrical contact 1108b. This can be attributed to the fact that the charging plug 190 is usually attached last or is only temporarily connected to the battery pack 100, in particular while the connector plug 194 which must “conduct” the electrical contact 1108b of the charging plug 190 to the battery pack 100 is already fastened to the battery pack 100. It is conceivable in this context, for example, that the PCB 1106b and the PCB 1106a are largely identical in their respective setup, but, depending on the need, in particular, fewer electrical connections are led to the outside to the surface of the charging plug 190. This can reduce the number of different parts if identical PCBs can be used for the charging plug 190 and the connector plug 192 and, for example, only the assembly with electrical components, such as the electrical contacts 1108a and 1108b, varies.

FIGS. 4a and 4b each show a three-dimensional representation of a charging connection of a battery pack 100. In the lower area of the two FIGS. 4a and 4b, the battery body 194 of the battery pack 100 is partially visible. In the upwardly terminating area of the battery body 194, the connector plug 192 is already put on in FIG. 4a. In the representation selected in FIG. 4a, the connector plug 192 comprises a circumferential sealing lip 196 pointing radially inward with respect to an axial longitudinal extension of the battery body 194. The sealing lip 196 is located in the axial direction below a projecting circumferential collar 196a of the connector plug 192. The sealing lip 196 serves in particular to establish a sealing connection, i.e. a fluid-tight connection, between the connector plug 192 and the charging plug 190, which is not represented in FIG. 4a and can be put on the battery body 194 in the axial direction of extension. This is relevant in that the electrical connection points between the connector plug 192 and the charging plug 190 would corrode to an increased extent if moisture were to occur during an existing current flow between the connector plug 192 and the charging plug 190. At this point it should be noted in this regard that the connector plug 192, which was described above in the context with FIGS. 2a to 2c, does not have such a collar 196a and no sealing lip 196, but can be supplemented in a simple manner by these elements. Alternatively, it is of course also conceivable that the collar 196a and the sealing lip 196 are not provided on the connector plug 192 but on the charging plug 190. This would then have the advantage that the electrical contact 1108b of the charging plug 190 projecting out of the plane of the connector plug receives additional protection from mechanical damage by the collar 196a.

FIG. 4a further represents charging contacts 198 and communication contacts 200. The charging contacts 198 and the communication contacts 200 are located on the surface of the connector plug 192 enclosed by the sealing lip 196. Due to the arrangement of the charging contacts 198 and the communication contacts 200, a non-rotatable mounting of the charging plug 190, not represented, can be realized. The special arrangement of the charging contacts 198 and of the communication contacts 200 is to be understood as an example. In particular, the charging contacts 198 and the communication contacts 200 can be further subdivided. It is also conceivable that, in addition to the charging contacts 198 represented in FIG. 4a and the communication contacts 200, further contacts are provided on the surface of the connector plug 192 enclosed by the sealing lip 196. In the event that the electrical contact surface 1112a for the charging plug 190 on the connector plug 192 is embodied to be rotationally secure, for example half of the charging contacts 198 and the communication contacts 200 can be brought together in the interior of the connector plug 192 in order to realize a simple rotation security in this way. The connection surfaces of the battery pack 100 and of the connector plug 192 represented in FIGS. 4a and 4b each have no projection or no recess, as described, for example, from the preceding figures, in order to realize an anti-rotation protection. However, these can be supplemented in a simple manner.

FIG. 4b represents the upper part of the battery body 194 of the battery pack 100 without the connector plug 192, wherein the latter comprises, analogously to the free end of the connector plug 192, a sealing lip 208 arranged behind a collar 208a in an axial extension direction of the battery body 194 and which surrounds an end face of the battery body 194. An electrical contact surface in the form of communication contacts 202 and connecting contacts 206 is again indicated on the end face of the battery body 194, wherein the connection contacts 206 can optionally also be referred to as charging contacts. The connecting contacts 206 can be provided both for the electrical supply of a connected helmet light 10 with electrical energy and for charging the battery pack 100. It should further be noted that the respective communication contacts 200, 202 and the connecting contacts 206 or the charging contacts 198 are represented recessed with respect to the respective end face, i.e. are located below the outwardly pointing respective housing surface. This arrangement is optional, it can also be provided that all or at least some contacts terminate flush with the outwardly facing respective housing surface. Further, it is again possible to arrange the sealing lip 208 and the associated collar 208a on the connector plug 192. The electrical contact surface again corresponds to the supply and communication terminal 14 from FIGS. 1k and 1j.

Further, magnets 204 are indicated on the end face of the battery body 194, which can hold the connector plug 192 on the battery body 194 in a desired connecting position. The sealing lip 208, like the sealing lip 196 on the connector plug 192, ensures the water-protected electrical contact between the battery body 194 and the connector plug 192 connectable thereto or the charging plug 190, if the latter is connected directly to the battery body 194 for charging the battery pack 100. The magnets 204 are represented in FIG. 4b on the visible surface of the end face of the battery body 194. However, they can also be arranged invisibly, in particular to prevent corrosion of the magnets 204, under the protective outer casing of the battery body 194, i.e. within the housing of the battery body 194. The arrangement of the magnets 204 is optional. However, if the magnets 204 are present, they can, given a suitable selection of the poles pointing away from the battery body 194, not only serve to fix a plug to be connected in a desired position, but also provide an anti-rotation protection, provided that the plug to be connected, the connector plug 192 or the charging plug 190, likewise has magnets with a suitable orientation.

FIGS. 5a and 5b show an internal setup of a battery pack 100 from different viewing directions, wherein an explicit representation of electrical connection lines was dispensed with for reasons of simplicity. In FIGS. 5a and 5b, two battery cells 1118 can in each case be recognized. These battery cells 1118 have a conventional cylindrical shape in an axial direction of extension. The two battery cell 1118 are electrically connected to one another, parallel or in series, and together form a battery module 12. A PCB 1106d and a cover 1122 which is electrically insulated or insulating with respect to the PCB 1106d can be recognized on the surfaces which point downwards or rearwards in FIG. 5a and which point forwards or upwards in FIG. 5b. The cover 1122 can consist, for example, of sheet metal and be electrically insulated from the PCB 1106d. Also indicated on the PCB 1106d are further electrical contact surfaces already known from FIG. 4b, but in an arrangement different from FIG. 4b. In the center above the two battery cells 1118 forming the battery module 12, an also cylindrically shaped vibration module 16 is represented, which in a general manner translated electrical energy into a mechanical movement, which, again, generates a body sound in the form of a vibration. This can be done, for example, in a known manner by means of a small electric motor which comprises an imbalance on its rotating motor axis. When the vibration module 16 is an integral part of the battery pack 100, the external shape of the battery pack 100, in particular of the battery body 194, is adapted accordingly. Without an integrated vibration module 16, the battery body 194 can have the external shape with the indentation 26, for example, represented in FIG. 1j, wherein the indentation 26 is suitable for receiving an external vibration module 16, as still described, for example, in connection with FIG. 7. When the vibration module 16, however, is integrated into the battery pack 100, the battery body 194 can have the shape represented in FIG. 1k, wherein, instead of the indentation 26, the elevation shown in the Figure is entered below which the vibration module 16 is located.

The height of the elevation or the thickness of the vibration module 16 inserted into the indentation 26 is dimensioned such that the vibration module 16 presses against the helmet shell 36 of the protective helmet 30 or rests flush against it when the battery pack 100 is fastened to the helmet shell 36 with the help of the mounting means 214. In this way, the body sound generated by the vibration module 16 can be efficiently transferred to the helmet shell 36. In doing so, the helmet shell 36 acts like a resonance amplifier so that the vibration can be well perceived by the user of the protective helmet 30 and already a vibration with a low intensity (small energy content) can be well perceived. This applies in particular even if the user is wearing the hearing protection 34 indicated in FIG. 9 since the body sound generated by the vibration module 16 can be well perceived as a tactile signal under the helmet shell 36.

In addition to the PCB 1106d, a further PCB 1106c is located on the upwardly facing surface of the battery cells 1118, on which a foil cover 1120 is indicated, which can have both a key and a display functionality for the battery pack 100. The key and display functionality of the foil cover 1120 has already been explained previously in the context with FIGS. 1c and 1d. The PCB 1106d and/or the further PCB 1106d can be equipped with electronic components explicitly not represented, which together form a control unit of the battery pack 100 in the sense of the present application. This control unit of the battery pack 100 is adapted to at least implement basic functions of the battery pack 100 after receiving a corresponding request signal, for example an activation of the vibration module 16 based on a receive communication signal or an automatic activation of the vibration module 16 as a response to the connection or pulling of a plug on the battery pack 100. The components represented in FIG. 5b can be cast, for example, into the housing of the battery body 194 or otherwise integrated in order to form the battery pack 100, as indicated in the miniature representation in the upper right-hand corner of FIG. 5b, wherein the battery pack 100 is shown there together with the connector and charging plugs 190, 192, which are not described in detail thereon. The external shape of the battery pack 100 can of course be of variable design and, in particular, does not have to correspond exactly to the miniature representation.

A battery pack temperature sensor can also be arranged inside the battery pack 100 or on its surface. This battery pack temperature sensor can detect a battery pack operating temperature value of the battery pack 100 which is transmitted, for example, to a control controller of the helmet light 10 and received by it. Based on the received battery pack temperature value, the control controller can then change an operating state of the helmet light 10, for example in order to keep the battery pack 100 within a tolerable temperature range. The detected temperature value can further also be the basis for the output of a tactile vibration signal through the vibration module 16. The battery pack 100 further comprises an electrical heating unit, which can be controlled by the control controller, in particular based on the received battery pack temperature value. For example, the control controller can switch on the electrical heating unit if the battery pack 100 falls below a lower temperature threshold value T_{Akku_min}. The switching off of the electric heating unit can, of course, also be temperature-controlled, advantageously in a hysteresis-like manner when another threshold value is exceeded, which is somewhat greater than the lower temperature threshold value T_{Akku_min}. The control controller can further lower a light output of the helmet light 10 if the detected battery pack operating temperature value of the battery pack 100 exceeds a tolerable temperature threshold value T_{Akku_max}. By lowering the light output, i.e. a reduction in the brightness of the helmet light 10, the electrical power taken from the battery pack 100 is reduced, which directly causes a reduction in the waste heat produced, so that the temperature of the battery pack 100 can fall, wherein a constant rate of emission of the waste heat to the environment is assumed. This can be advantageous, for example, in an environment at risk of explosion. Reaching particular temperature values, for example T_{Akku_min} or T_{Akku_max}, can also trigger the output of a vibration signal through the vibration module.

FIGS. 6a to 6h show various three-dimensional representations of a mounting means 214. In the present case, the represented mounting means 214 is a battery holder 214 with the help of which the battery pack 100 can be fixed on the protective helmet 30. The mounting means 214, which is at least partially represented in each case, comprises a frame 220 into which the previously described battery pack 100 can be inserted in an axial insertion direction. For this purpose, the frame 220 of the mounting means 214 has a substantially cylindrical outer structure with a rectangular base surface with rounded edges. As can be recognized in FIG. 6a, the frame 220 is narrowed at one end face in the axial direction of extension, so that the battery pack 100 cannot enter into the frame 220 or exit from it at this side. On the opposite end face in the axial direction of extension of the frame 220, the latter is, however, formed in its cross-section substantially not narrowed relative to the rest of the frame 220, so that the battery pack 100 can be inserted from this side into the frame 220 of the mounting means 214. The cylindrical structure of the frame 220 of the mounting means 214 permits the easy insertion of a battery pack 100 with a constant cross-section. The battery pack 100 can be fixed in the frame 220 of the mounting means 214 by means of an elastic tab 224. If the battery pack 100 comprises an integrated vibration module 16 with the elevation caused by it, which represents a projection, the frame can have a corresponding recess in order to enable the battery pack 100 to be slid in. With the help of the tapering, a stop can be realized when inserting a battery pack 100 into the mounting means 214, wherein the tab 224 arranged at the other end simultaneously clamps the inserted battery pack 100 within the frame 220. The frame 220 of the mounting means 214 encloses the space in which the battery pack 100 can be arranged such that substantial areas remain free, so that the battery pack 100 remains visible through the frame 220 of the mounting means 214. In this way, in particular, a sufficient heat dissipation of the battery pack 100 during a charging/discharging process can be ensured, since the frame 220 does not additionally thermally insulate the inserted battery pack 100 from the environment.

The frame 220 of the mounting means 214 is further adjoined by upper holding arms 216a and 216b. The upper holding arms 216a and 216b each open into upper holding hooks 218a, 218b, which ultimately serve to fasten the mounting means 214 to a helmet shell 36. The upper holding hooks 218a and 218b each comprise a step 223 which receives the displaceability of a ventilation slide 50 on a helmet shell 36. Further, lower holding hooks 222a and 222b are also arranged directly on the frame 220 of the mounting means 214. The upper and lower holding hooks 218a, 218b, 222a and 222b serve together for the secure fixing of the mounting means 214 to a helmet shell 36. The exact interaction of the upper and lower holding hooks 218a, 218b, 222a and 222b with the helmet shell 36 will be described in more detail later.

FIG. 6a further indicates the vibration module 16 on the lower side of the frame 220 between the two lower holding hooks 222a and 222b. At this position, the vibration module 16 can either be detachably fixed or be an integral part of the frame 220 of the mounting means 214. The height/thickness of the vibration module 16 is dimensioned such that the vibration module 16 presses against the helmet shell 36 of the protective helmet 30 or rests flush against it when the mounting means 214 is fastened to the helmet shell 36. In this way, the body sound generated by the vibration module 16 can be efficiently transmitted to the helmet shell 36. In doing so, the helmet shell 36 acts like a resonance amplifier so that the vibration can be well perceived by the user of the protective helmet 30. This applies in particular even if the user is wearing the hearing protection indicated in FIG. 9 since the body sound generated by the vibration module 16 can be perceived as a tactile signal under the helmet shell 36.

The special design of the mounting means 214 described in FIGS. 6a to 6h serves to guarantee the safety of a user of the protective helmet 30. Thus, by providing the upper and lower holding hooks 218a, 218b, 222a, 222b, a fixed positioning of the mounting means 214 on the helmet shell 36 is achieved, which is nevertheless easily detachable if this should be necessary. An object impinging from above on the protective helmet 30, for example a branch, can slide down on the protective helmet 30 and, in the process, if it should catch with the mounting means 214, release the mounting means 214 from the protective helmet 30 without the protective helmet 30 being torn from the head of a user wearing the protective helmet 30 and without the user experiencing the full impact force of the impinging object.

The orientation of the open hooking sides of the upper holding hooks 218a, 218b in the direction of the open hooking sides of the lower holding hooks 222a, 222b ensures that, in the case of an object impinging from above on the protective helmet 30 and impinging on the mounting means 214, a release force is generated which first loads the closed side of the upper holding claws 218a, 218b, so that they may break under the impact force and thus initiate a release of the mounting means 214 from the helmet shell 36. At the same time, the lower holding claws 222a, 222b are pushed down in their open direction by the helmet shell 36 and the mounting means 214 is thereby completely released from the helmet shell 36. Since the open hooking sides of the upper holding hooks 218a, 218b are larger than the open hooking sides of the lower holding hooks 222a, 222b, as represented in the figures, the mounting means 214 can be easily fastened to the helmet shell 36, since the bending of the upper holding hooks 218a, 218b during the fastening process requires a comparatively small force. At the same time, the force required for breaking the upper holding hooks 218a, 218b is kept comparatively small by this configuration, so that the release of the mounting means 214 in the event of an emergency, that is to say in the case of an object impinging from above on the protective helmet 30, also takes place simply and easily.

The mounting means 214 comprises on its lower side, which can be seen, for example in FIGS. 6c and 6d, metallic, electrically conductive contacts 22 which enable an electrical contact with a vibration module 16 which can be fixed on this location. In doing so, the vibration module 16 is slid on the lower side of the frame 220 in the direction of the lower holding hooks 222a and 222b engages there in a defined final position. The two lower holding hooks 222a and 222b can support this in particular in connection with the frame 220 through correspondingly designed clamping ribs, for example, Further, the contacts 22 can also be embodied as magnets and fix the vibration module 16 in the intended final position. The contacts 22 generally only provide simple contacts through the frame 220 and, in this way, connect the vibration module 16 to associated electrical connections on the battery body 194. Correspondingly, the contacts 22 are also visible on the inner side of the frame 220, for example in FIG. 6b.

FIGS. 7 and 8 each show a three-dimensional view of the vibration module 16. The respective represented vibration modules 16 are formed as vibration modules 16 which can be fastened to the mounting means 214 or to the battery body 194. For this purpose, the vibration module 16 which can be fastened to the battery body 194, which is represented in FIG. 7, is formed to be substantially cylinder-shaped, wherein the basic surfaces of the vibration module 16 are formed to be rectangular, in particular square, with a “cut-off” corner. The part of the side surface of the cylinder lateral surface which connects the “cut-off” corners forms a bearing surface 20. The bearing surface 20 rests on the outer side of the helmet shell 36 in order to transmit the generated body sound when the battery body 100 is mounted with the vibration module 16 to the protective helmet 30. At the same time, the “edge” of the lateral surface opposite the bearing surface 20 is flush in the recess 26 on the battery body 194. Further, contacts 22 for electrically connecting the vibration module 16 to the battery pack 100 are provided on the two basic surfaces of the vibration module 16. In a similar manner, the vibration module 16 represented in FIG. 8 is substantially formed to be cuboid in order to allow a releasable fixation of the vibration module 16 on the mounting means 214. However, the contacts 22 provided there are not arranged on the “end faces”, but on a part of the lateral surface connecting these. Both in the vibration module 16 represented in FIG. 7 and in the vibration module 16 represented in FIG. 8, the contacts 22 can be formed as magnets in order to support or enable the fixation on the battery body 194 or on the mounting means 214.

The protective helmet 30, which is formed in particular for use in forestry, is shown in a side view in FIG. 9 partly in section. Thus, in particular, an inner side of the helmet shell 36 is visible. The protective helmet 30 comprises a face protection not represented in FIG. 9 and a hearing protection 34. Further, the protective helmet 30 comprises the helmet shell 36 and an interior fitting assembly not mentioned in more detail, which comprises a support cage 42, a head band 44 and a neck band. The neck band is equipped with a tensioning unit. The helmet shell 36 is provided on the outside with a ventilation slide 50, by means of which openings formed in the helmet shell 36 can be opened and closed. The openings at the same time contribute to the fixation of the mounting means 214 on the helmet shell 36 by the upper holding hooks 218a and 218b projecting into the openings 50 and engaging there. At the same time, the lower holding hooks 222a and 222b comprise a lower rim of the helmet shell 36 so that the mounting means 214 fixes the battery pack 100 in the represented position in the region of the back head of the user on the helmet shell 36.

Three support arms formed as spacers serve as means for a three-point fastening of the interior fitting or the interior fitting assembly to the helmet shell 36, wherein only the rear support arm is to be anticipated within the protective helmet 30 in FIG. 9. For locking this support arm extending in the longitudinal direction of the helmet shell 36 to the helmet shell 36, the latter is provided in the rear head area with a slot in which the correspondingly shaped free end of the support arm pointing in the longitudinal direction can releasably engage on the helmet shell 36. The helmet shell 36 and the support arms are dimensioned and arranged (i.e. dimensioned so long and so wide in their clear width) that a free space is present between the interior fitting assembly 40 and the helmet shell 36 for receiving the helmet light 10, the associated wiring, hearing protection capsules 35a of the hearing protection 34 and other helmet accessories, as well as fastening devices 84a and 80a at least for the face protection and the hearing protection 34. The other helmet accessories include the already mentioned tensioning unit of the neck band. In FIG. 9, the connection cable 24 is laid as an example within the helmet shell 36 and exits the helmet shell 36 directly below the battery pack 100 in order to electrically connect the helmet light 10 to the battery pack 100.

FIG. 10 shows a flow chart of a method 300 for operating a helmet accessory system. The method starts with receiving 310 a communication signal at the supply and communication terminal 14 of the battery pack 100. For example, the communication signal can be an information signal that a mobile phone connected to the battery pack 100 is receiving a call. Based on this received communication signal, the vibration module 16 can then be driven through the control unit in a subsequent step. This means that the vibration module 16 is used as an additional alarm unit or ring or vibration unit of the connected mobile phone, so to say. This is advantageous in that, in this way, the user of the protective helmet 30 can be notified in a reliable and tactile manner. This in particular enables to notify the user even if the user is using the hearing protection 34 integrated in the protective helmet 30. It is to be noted that the actual alarm of the mobile phone, the acoustic alarm and the vibration alarm, can often be received only poorly be the user when using the protective helmet 30. Thus, the acoustic signal is suppressed by the hearing protection 34 and the vibration alarm of the mobile phone can often also be received only poorly due to (cushioned) protective clothing. The vibration caused by the vibration module 16, on the other hand, directly addresses the head of the user via the helmet shell 36 so that an improved perceptibility of the vibration of the vibration module 16 (compared to the vibration alarm of the mobile phone) is given.

The vibration module 16 can furthermore also be driven for signalling further events. For this purpose, it is only required that a communication signal provided for activating the vibration module 16 is sent to and received by the supply and communication terminal 14 of the battery pack 100. For example, the vibration module 16, through the mobile phone connected to the battery pack 100, can generally be used as a “bell” which is always driven when the mobile phone issues an acoustic or tactile signal due to different events. For example, it is possible to signal notifications received by the mobile phone or a low battery status of the mobile phone in a tactile manner. In doing so, different events can trigger different vibration patterns of the vibration module 16. Correspondingly, the vibration pattern can vary depending on the event and identify them in a unique manner. It is also possible that the helmet light 10 sends a communication signal to the supply and communication terminal 14 of the battery pack 10 in order to activate the vibration module 16. This can indicate, for example, a (pending) change of the operating mode of the helmet light 10. It is also possible to trigger a vibration signal through the vibration module 16 due to a dangerous situation recognized by a sensor unit of the helmet light 10 or the battery pack 100. It is also possible to communicate a charging or discharging state of the battery pack 100 by the vibration module 16 itself in a tactile manner.

In order to support the perception of the vibration module 16 through the user, it is conceivable and possible to additionally provide a variation of the light cone emitted by the helmet light 10. For example, a brightness or a diameter of the one or more or at least some light cones which are generated by the helmet light 10 can be synchronized or varied with the emitted vibration signal, in particular, the emitted brightness/light color can be cyclically increased and lowered or varied.

The features of the invention disclosed in the above description, in the drawings and in the claims can be essential for the realization of the invention both individually and in any combination.

### LIST OF REFERENCE NUMERALS

10 helmet light
12 battery module
14 supply and communication terminal
16 vibration module
18 holding means
20 bearing surface
22 contact
26 recess
24 connection cable
30 protective helmet
34 hearing protection
35a hearing protection capsule
36 helmet shell
44 head band
50 ventilation slide
84a fastening devices
80a fastening devices
100 battery pack
102 display and operating element
190 charging plug
192 connector plug
194 battery body
196 sealing lip
196a collar
198 charging contact
200 communication contact
202 communication contact
204 magnet
206 charging contact
208 sealing lip
208a collar
212 detent lug
214 mounting means
216a upper holding arm
216b upper holding arm
218a upper holding hook
218b upper holding hook
220 frame
222a lower holding hook
222b lower holding hook
223 step
224 tab
300 method
310 receiving
320 driving
1104a magnet
1104b magnet
1106a PCB
1106b PCB
1106c PCB
1106d PCB
1108a electrical contact
1108b electrical contact
1110a casting compound
1110b casting compound
1112a electrical contact surface
1112b electrical contact surface
1112c electrical contact surface
1114a recess
1114b recess
1116a projection
1116b projection
1118 battery cell
1120 foil cover
1122 cover
1124 end face
2002 battery charging level display
2004 on/off button
2006 LED backlight
2008 display area

1.-12. (canceled)

13. A battery pack for fastening to a protective helmet and for energy supply of a helmet accessory, comprising:
a battery module for storing and outputting electrical energy;
a supply and communication terminal for energy supply of a helmet accessory which can be coupled with the battery pack and for communication;
mounting means for fastening the battery pack to the protective helmet;
a vibration module for generating body sound;
a control unit for controlling the functions of the battery pack, including the function of the vibration module;
wherein the control unit is adapted to drive the vibration module based on a communication signal received at the supply and communication terminal.

14. The battery pack according to claim 13, wherein the vibration module is integrated in a battery body or is integrally formed with the mounting means.

15. The battery pack according to claim 13, wherein the vibration module is detachably fastened to the battery body or detachably fastened to the mounting means.

16. The battery pack according to claim 15, wherein the vibration module comprises holding means which fix the vibration module to the battery pack or to the mounting means.

17. The battery pack according to claim 16, wherein the holding means are adapted to magnetically or mechanically fix the vibration module.

18. The battery pack according to claim 15, wherein an electrical connection between the battery pack and the vibration module is formed by means of the holding means.

19. The battery pack according to claim 13, wherein the vibration module comprises a bearing surface which bears against a helmet shell of the protective helmet when the battery pack is fastened to the protective helmet by means of the mounting means.

20. The battery pack according to claim 13, characterized in that the battery pack comprises at least one sensor unit which detects an operating state of the battery pack and in that the control unit is adapted to drive the vibration module based on the detected operating state.

21. The battery pack according to claim 13, wherein the control unit is formed to drive the helmet accessory synchronously with the vibration module.

22. A helmet accessory system comprising:
a battery pack according to claim 13 and a helmet accessory,
wherein the battery pack and the helmet accessory can be fastened or are fastened to a helmet shell of the protective helmet;
wherein the helmet accessory is a helmet light.

23. A protective helmet system, comprising a protective helmet and a helmet accessory system according to claim 10.

24. A method for operating a helmet accessory system according to claim 22, wherein the method comprises:
receiving a communication signal on a supply and communication terminal of the battery pack, and
driving, through a control unit, a vibration module based on the received communication signal.
